(19) United States
(12) Patent Application Publication
(10) Pub. No.: US 2020/0345119 A1
(43) Pub. Date: Nov. 5, 2020

(54) WATER COMB AND BRUSH SHOWERHEAD ATTACHMENT SYSTEM

(71) Applicant: Audrey Yvette Van Weems, Menifee, CA (US)

(72) Inventor: Audrey Yvette Van Weems, Menifee, CA (US)

(21) Appl. No.: 16/856,576

(22) Filed: Apr. 23, 2020

Related U.S. Application Data
(60) Provisional application No. 62/841,926, filed on May 2, 2019.

(51) Int. Cl. A45D 24/22; A45D 19/02; B05B 1/18

(52) U.S. Cl. CPC A45D 24/22; B05B 1/185; A45D 19/02

(57) ABSTRACT

A water comb and brush shower head attachment system; the water comb and brush shower head attachment system includes a shower head assembly including an attachment member configured to be attached directly to a host-showerhead, a water flow directing member configured to provide directional water flow, and a tube system for delivering water from the attachment member to a combination brush and comb unit having a series of bristles and a series of water dispensing apertures configured to deliver the water during use. The device delivers pressurized water to the brush and comb unit to be used for detangling and separating hair strands during use.

### CROSS-REFERENCE TO RELATED APPLICATION

The present application is related to and claims priority to U.S. Provisional Patent Application No. 62/841,926 filed May 2, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of haircare devices of existing art and more specifically relates to a shower head attachment for haircare.

### RELATED ART

Some hairstyles and hair types are naturally prone to tangle or mat within just a few hours, days, weeks, etc. It can be immensely painful trying to untangle hair with a standard comb and brush. Some people may resort to chemicals that can damage the hair. Others may decide to cut their hair to get rid of a tangle or mat. A suitable solution is desired.

U.S. Pat. No. 6,244,273 to Lieutenant Higgins relates to a water comb. The described water comb includes a comb that is attachable to a faucet to allow water to run through the comb's hollow-shaped inner body. The water travels through the faucet, plastic or rubbertubing, the comb's inner body, and exits through the comb's hollow-shaped teeth with an exit portal at the tip. The comb's two assemblies are a shower adapter, essentially tubing for the shower arm and connector on the comb, and the water holes, allowing water to flow through the comb. The shower adapter also has a bi-directional valve on it to direct water either to the comb or the shower head.

### SUMMARY OF THE INVENTION

In view of the foregoing disadvantages inherent in the known shower head attachments for haircare art, the present disclosure provides a novel water comb and brush shower head attachment system. The general purpose of the present disclosure, which will be described subsequently in greater detail, is to provide a shower head attachment used for detangling hair.

A water comb and brush shower head attachment system is disclosed herein. The water comb and brush shower head attachment system includes a shower head assembly including a funnel-shaped attachment member configured to be attached directly to a host-showerhead, a water flow directing member configured to provide directional water flow, and a tube system for delivering water from the attachment member to a combination brush and comb unit having a series of bristles and a series of water dispensing apertures configured to deliver the water during use. The brush and comb unit is hollow allowing water to flow therethrough. The brush and comb unit includes a brush-head on a first-side and a comb-head on an opposing second-side, the brush-head and the comb-head being able to be used interchangeably. The brush-head of the first-side of the brush and comb unit comprises a plurality of rows of the series of bristles. The comb-head of the second-side of the brush and comb unit comprises a single linear row of the series of bristles. The series of water dispensing apertures are evenly distributed about the first-side and the second-side of the brush and comb unit to evenly disperse the water during use to assist a user in a hair detangling process.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a water comb and brush shower head attachment system, constructed and operative according to the teachings of the present disclosure.

FIG. 1 is a perspective view of the water comb and brush shower head attachment system during an ‘in-use’ condition, according to an embodiment of the disclosure.

FIG. 2 is a perspective view of the water comb and brush shower head attachment system of FIG. 1, according to an embodiment of the present disclosure.

FIG. 3 is a perspective view of the water comb and brush shower head attachment system of FIG. 1, according to an embodiment of the present disclosure.

FIG. 4 is a perspective view of the water comb and brush shower head attachment system of FIG. 1, according to an embodiment of the present disclosure.

FIG. 5 is a perspective view of the water comb and brush shower head attachment system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a shower head attachment for haircare and more particularly to a water comb and brush shower head attachment system as used to improve the process of detangling of hair.

Generally, the water comb and brush shower head attachment system provides users with a combination comb and brush tool capable of instantly de-tangling all types of hair without the need for shampoos or conditioners. It features a series of bristles to construct a brush head on one side and a single line of bristles on the opposite side to construct a comb. This allows water to flow through both sides of the device via a series of holes located on and near the bristles, ensuring the bristles remain wet while de-tangling matted hair. It utilizes a funnel and hose attachment to the shower head that directs water from the plumbing system through the device. It offers a more effective method of de-tangling hair, saving an extensive amount of time and effort during a daily routine.

More specifically, the device is a modified shower head attachment used for detangling matted hair. The device is comprised of the shower head attachment, a cloth bag with a drawstring to provide directional water flow, a tube system, and a combination brush and comb unit. The shower head section can be connected directly to the shower head and then secured to the tube, allowing water to flow from the shower head through the device. The brush/comb tool can feature a series of holes on both sides and throughout the bristles used to receive water. On one side can be a series of bristles that form a hairbrush while the opposite side can have a single line of bristles mimicking a comb. Water passes through the device and out the holes, wetting the bristles in the process.

The brush or comb sections can be used as needed to detangle hair. The cloth drawstring bag prevents further dampening of the hair or body. The system offers an alternative to shampoos, conditioners, and other methods of detangling hair. There can also be a built-in shower spray at the base of the funnel when the hose is detached for a hands-free option for finger detangling the hair.

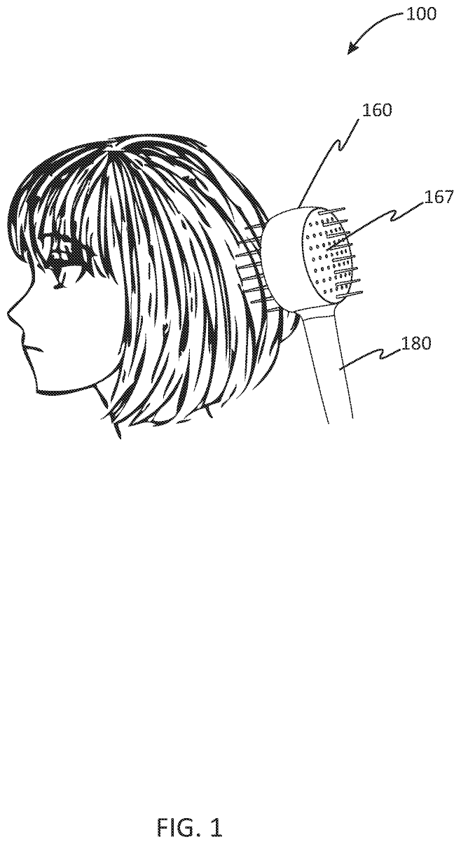

Referring now more specifically to the drawings by numerals of reference, there is shown in FIGS. 1-5, various views of a water comb and brush shower head attachment system 100.

FIG. 1 shows a water comb and brush shower head attachment system 100 during an ‘in-use’ condition 150, according to an embodiment of the present disclosure. Here, the water comb and brush shower head attachment system 100 may be beneficial for use by a user to detangle matted and tangled hair. As illustrated, the water comb and brush shower head attachment system 100 may include a shower head assembly 110 including an attachment member 120 configured to be attached directly to a host-showerhead 10, a water flow directing member 130 configured to provide directional water flow, and a tube system 140 for delivering water from the attachment member 120 to a combination brush and comb unit 160 having a series of bristles 162 and a series of water dispensing apertures 170 configured to deliver the water during use.

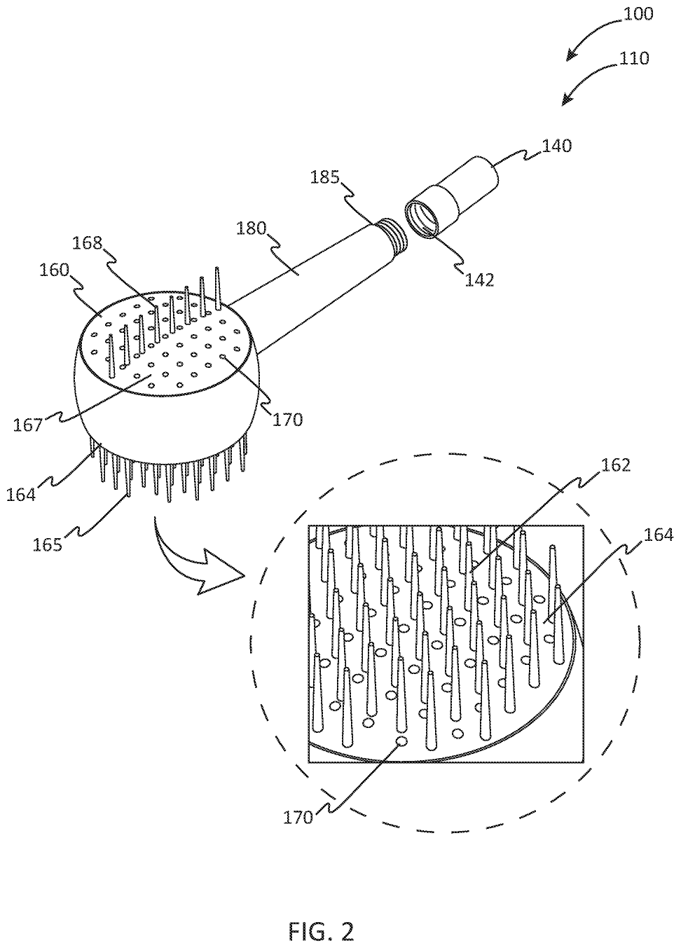

FIG. 2 shows the water comb and brush shower head attachment system 100 of FIG. 1, according to an embodiment of the present disclosure. As above, the water comb and brush shower head attachment system 100 may include the shower head assembly 110 including the attachment member 120, the water flow directing member 130, and the tube system 140 for delivering water from the attachment member 120 to the combination brush and comb unit 160 having the series of bristles 162 and the series of water dispensing apertures 170. In one embodiment, the attachment member 120 comprises a funnel-shaped configuration for directing water dispensed from the host-showerhead 10 and water source. The attachment member 120 includes a threaded partially open-end 122. The threaded partially open-end 122 comprises a set of water delivering apertures 124 which are configured to allow for passage of water from the attachment member 120 to the tube system 140. The tube system 140 is flexible and comprises a mating threaded-section 142 for attachment to the threaded partially open-end 122 of the attachment member 120.

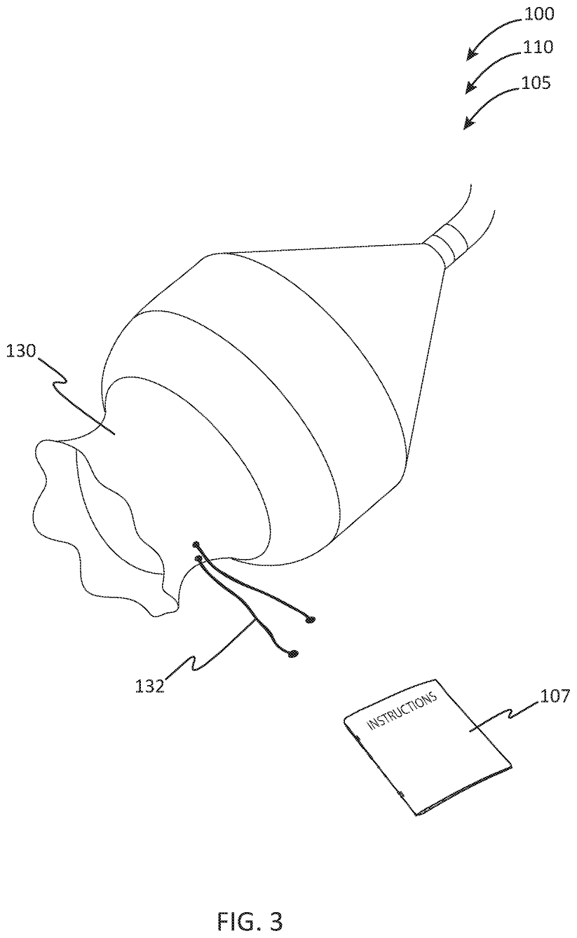

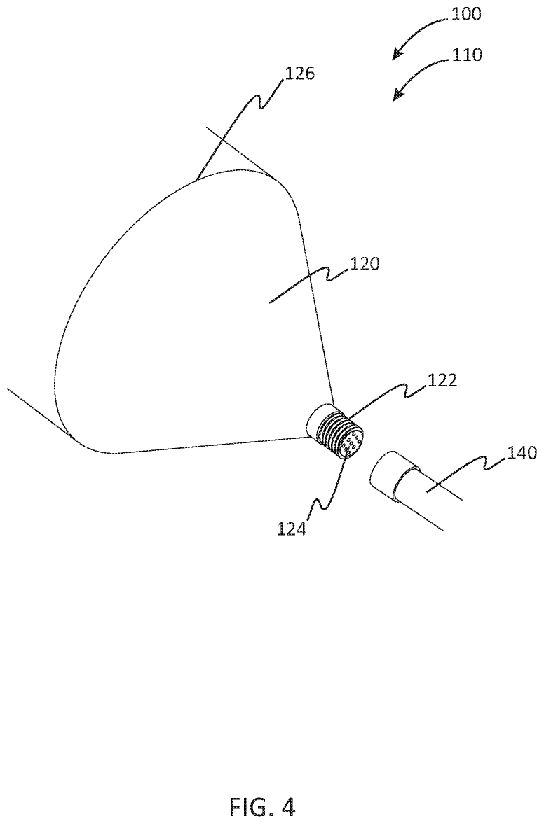

FIGS. 3-4 show perspective views of the water comb and brush shower head attachment system 100 of FIG. 1, according to an embodiment of the present disclosure. The water comb and brush shower head attachment system 100 features a brush and comb unit 160 having the series of bristles 162 and the series of water dispensing apertures 170. The brush and comb unit 160 is hollow allowing water to flow therethrough. The brush and comb unit 160 includes a brush-head 165 on a first-side 164 and a comb-head 168 on an opposing second-side 167. The brush-head 165 and the comb-head 168 being able to be used interchangeably. The brush-head 165 of the first-side 164 of the brush and comb unit 160 comprises a plurality of rows of the series of bristles 162. The comb-head 168 of the second-side 167 of the brush and comb unit 160 comprises a single linear row of the series of bristles 162. The series of water dispensing apertures 170 are evenly distributed about the first-side 164 and the second-side 167 of the brush and comb unit 160 to evenly disperse the water during use. The series of water dispensing apertures 170 are positioned proximal to the series of bristles 162. The brush and comb unit 160 further comprises an elongated handle 180. The tube system 140 is connected at an end-portion 185 of the elongated handle 180 of the brush and comb unit 160. In a preferred embodiment, the water flows to the brush-head 165 and comb-head 168 simultaneously during use.

According to one embodiment, the water comb and brush shower head attachment system 100 may be arranged as a kit 105. In particular, the water comb and brush shower head attachment system 100 may further include a set of instructions 107. The instructions 107 may detail functional relationships in relation to the structure of the water comb and brush shower head attachment system 100 such that the water comb and brush shower head attachment system 100 can be used, maintained, or the like, in a preferred manner.

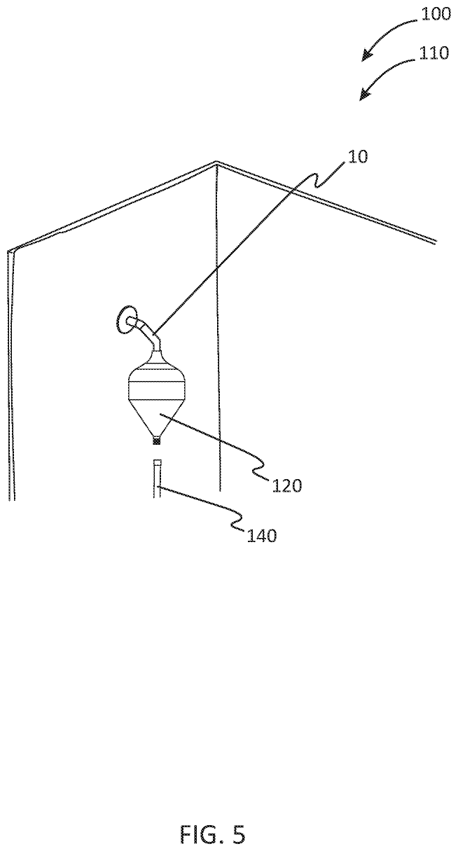

FIG. 5 is a perspective view of the water comb and brush shower head attachment system 100 of FIG. 1, according to an embodiment of the present disclosure. The water flow directing member 130 of the shower head assembly 110 may comprise a cloth bag or other suitable water directing member. The cloth bag preferably comprises a drawstring 132. The drawstring 132 is configured to be cinched to further secure the attachment member 120 to the host-showerhead 10. The water flow directing member 130 is connected to an open-end 126 of the attachment member 120 opposing the threaded partially open-end 122. In certain embodiments, the brush and comb unit 160 is attachable directly to the attachment member 120 for hands-free operation. In this embodiment, the tube system 140 is not provided. The water is pressurized and delivered via the brush and comb unit 160 to detangle and separate hair strands during use.

It should also be noted that, under appropriate circumstances, considering such issues as design preference, user preferences, marketing preferences, cost, structural requirements, available materials, technological advances, etc., other methods of use, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A water comb and brush shower head attachment system, the system comprising:
a shower head assembly including
an attachment member configured to be attached directly to a host-showerhead;
and
a water flow directing member configured to provide directional water flow;
a tube system for delivering water from the attachment member to a combination brush and comb unit having
a series of bristles;
and
a series of water dispensing apertures configured to deliver the water during use.

2. The water comb and brush shower head attachment system of claim 1, wherein the attachment member comprises a funnel-shaped configuration having a threaded partially open end.

3. The water comb and brush shower head attachment system of claim 2, wherein the threaded partially open-end comprises a set of water delivering apertures configured to allow for passage of water from the attachment member to the tube system.

4. The water comb and brush shower head attachment system of claim 3, wherein the tube system comprises a mating threaded-section for attachment to the threaded partially open-end of the attachment member.

5. The water comb and brush shower head attachment system of claim 1, wherein the tube system is flexible.

6. The water comb and brush shower head attachment system of claim 1, wherein the brush and comb unit is hollow.

7. The water comb and brush shower head attachment system of claim 6, wherein the brush and comb unit includes a brush-head on a first-side and a comb-head on an opposing second-side, the brush-head and the comb-head being able to be used interchangeably.

8. The water comb and brush shower head attachment system of claim 7, wherein the brush-head of the first-side of the brush and comb unit comprises a plurality of rows of the series of bristles.

9. The water comb and brush shower head attachment system of claim 8, wherein the comb-head of the second-side of the brush and comb unit comprises a single linear row of the series of bristles.

10. The water comb and brush shower head attachment system of claim 7, wherein the series of water dispensing apertures are evenly distributed about the first-side and the second-side of the brush and comb unit to evenly disperse the water during use.

11. The water comb and brush shower head attachment system of claim 7, wherein the brush and comb unit further comprises an elongated handle, said tube system is connected at an end-portion of the elongated handle of the brush and comb unit.

12. The water comb and brush shower head attachment system of claim 10, wherein the water flows to the brush-head and comb-head simultaneously during use.

13. The water comb and brush shower head attachment system of claim 10, wherein the water dispensing apertures are positioned proximal to the series of bristles.

14. The water comb and brush shower head attachment system of claim 1, wherein the water flow directing member comprises a cloth bag.

15. The water comb and brush shower head attachment system of claim 14, wherein the cloth bag comprises a drawstring, the drawstring is configured to be cinched to further secure the attachment member to the host-showerhead.

16. The water comb and brush shower head attachment system of claim 2, wherein the water flow directing member is connected to an open-end of the attachment member opposing the threaded partially open-end.

17. The water comb and brush shower head attachment system of claim 1, wherein the brush and comb unit is attachable directly to the attachment member for hands-free operation.

18. The water comb and brush shower head attachment system of claim 1, wherein the water is pressurized and delivered via the brush and comb unit to detangle and separate hair strands during use.

19. A water comb and brush shower head attachment system, the water comb and brush shower head attachment system comprising:
a shower head assembly including;
an attachment member configured to be attached directly to a host-showerhead;
and
a water flow directing member configured to provide directional water flow;
a tube system for delivering water from the attachment member to a combination brush and comb unit having;
a series of bristles;
and
a series of water dispensing apertures configured to deliver the water during use;
wherein the attachment member comprises a funnel-shaped configuration having a threaded partially open end;
wherein the threaded partially open-end comprises a set of water delivering apertures configured to allow for passage of water from the attachment member to the tube system;
wherein the tube system comprises a mating threaded-section for attachment to the threaded partially open-end of the attachment member;
wherein the tube system is flexible;
wherein the brush and comb unit is hollow;
wherein the brush and comb unit includes a brush-head on a first-side and a comb-head on an opposing second-side, the brush-head and the comb-head being able to be used interchangeably;
wherein the brush-head of the first-side of the brush and comb unit comprises a plurality of rows of the series of bristles;
wherein the comb-head of the second-side of the brush and comb unit comprises a single linear row of the series of bristles;
wherein the series of water dispensing apertures are evenly distributed about the first-side and the second-side of the brush and comb unit to evenly disperse the water during use;
wherein the brush and comb unit further comprises an elongated handle, said tube system is connected at an end-portion of the elongated handle of the brush and comb unit;
wherein the water flows to the brush-head and comb-head simultaneously during use;
wherein the water dispensing apertures are positioned proximal to the series of bristles;
wherein the water flow directing member comprises a cloth bag;
wherein the cloth bag comprises a drawstring, the drawstring is configured to be cinched to further secure the attachment member to the host-showerhead;
wherein the water flow directing member is connected to an open-end of the attachment member opposing the threaded partially open-end; and
wherein the water is pressurized and delivered via the brush and comb unit to detangle and separate hair strands during use.

20. The water comb and brush shower head attachment system of claim 19, further comprising a set of instructions, wherein the water comb and brush shower head attachment system is arranged as a kit.
